(19) United States
(12) Patent Application Publication
(10) Pub. No.: US 2024/0261178 A1
(43) Pub. Date: Aug. 8, 2024

(54) SYSTEM FOR GENERATING TACTILE STIMULATIONS

(71) Applicants: Université Claude Bernard Lyon 1, VILLEURBANNE (FR); INSTITUT NATIONAL DE LA SANTE ET DE LA RECHERCHE MEDICALE, PARIS (FR); Centre national de la recherche scientifique, PARIS (FR); UNIVERSITE JEAN MONNET SAINT ETIENNE, SAINTE-ETIENNE (FR)

(72) Inventors: Silvia MACCHIONE, LYON (FR); Alessandro FARNE, DAGNEAUX (FR); Hubert R. DINSE, FRONDENBERG (DE); Roméo SALEMME, BOURGOIN-JALLIEU (FR); Dollyane MURET, LONDON (GB)

(21) Appl. No.: 18/563,980

(22) PCT Filed: Mar. 18, 2022
(86) PCT No.: PCT/IB2022/052466

§ 371 Date: Nov. 24, 2023

(30) Foreign Application Priority Data
Mar. 19, 2021 (FR) FR2102781

(51) Int. Cl. A61H 23/02

(52) U.S. Cl. CPC A61H 23/02; A61H 2201/1207; A61H 2201/5005; A61H 2201/5007; A61H 2205/022

(57) ABSTRACT

System (101) of tactile stimulations, corresponding method and computer program product. The system is configured to generate tactile stimulations, the generation times of which follow a Poisson distribution with a lambda parameter comprised between 0.5 and 1.5.

### FIELD OF THE INVENTION

The present invention relates to systems of tactile stimulation of a person's body. More particularly, the invention relates to systems for improving the tactile perception of one or a plurality of areas of the body via tactile stimulation of one or a plurality of other areas.

### PRIOR ART

Systems of tactile stimulations of an area of a person's body, e.g. an area of the face, are known. A tactile stimulation is a stimulation of the skin, at the area, by means of an actuator, e.g. a tactile actuator.

Tactile stimulation refers to a stimulation of a part of the body for an established duration. Thereby, a tactile stimulation is a stimulation of the skin, in one or a plurality of areas of the body, which is performed by an actuator. This actuator can e.g. be placed on or brought into contact with said area, which can remain immobile or move throughout the duration of the stimulation. No movement, action nor exercise is required because an improvement is achieved entirely passively. The expression somatosensory stimulation or passive tactile stimulation is also used.

One of the fields of application of such systems is the medical field, e.g. for treating sensorimotor deficits that are common to several pathologies as well as to aging.

The sensorimotor deficits can be caused by a stroke, which is the leading cause of sequelae entailing sensorimotor deficits. Other brain lesions, e.g. of traumatic or hemorrhagic origin, or lesions induced by neurodegenerative pathologies, can cause sensorimotor sequelae of the same type. Finally, sensorimotor deficits can also affect people who have undergone temporary immobilization of a limb.

Sensorimotor deficits include the loss of tactile perception in an area of the body. Such loss can have a negative impact on a plurality of functions such as e.g. the gripping and handling of objects (e.g. upper limbs), on the orofacial movements (e.g. face) and the maintenance of postural balance (e.g. sensorimotor control over lower limbs). A rehabilitation of sensorimotor deficits can be achieved by improving the tactile perception.

In addition, the systems to generate tactile stimulations can be used for improving the tactile perception of a person who does not have a previous deficit but wishes to increase his/her tactile perception in order to improve his/her sensorimotor performance: e.g. surgeons, musicians etc.

The systems to generate tactile stimulations can be used by anyone wishing to increase his/her manual functions for a personal/recreational and not specifically professional purpose, e.g. in the case of video game players, musicians and amateur sportsmen, people who want to improve their performance in specific activities such as reading Braille, etc.

Such systems to generate tactile stimulations can be used in industry, in particular in cosmetology and the textile industry. It is recognized that the different degree of tactile perception, on the hands as well as on the face, can modulate the choice in the application of certain cosmetic products on the skin compared to others, as well as the choice in the purchase of textile products. To do this, such systems which improve tactile perception can be used by professionals in the sector for targeting and guiding customer choices.

Patent application US 2019/117933 A1 describes devices and methods for cerebral stimulation by tactile stimulations of the user's head, where the tactile stimulations can be successive series of pulses the frequency of which can vary over time.

Patent applications US 2007/208280 A1 and US 2008/020972 A1 describe other examples of devices to generate tactile stimulations.

Current systems require tactile stimulation of the area for which tactile perception is to be improved. However, it is sometimes not possible or effective to carry out tactile stimulation on the area the performance of which is to be improved, in particular when the area is inaccessible, either temporarily, such as the hands of a person wearing gloves, such as a surgeon, or in a more lasting way, e.g. a damaged area.

Therefore, there is a need for systems to generate tactile stimulations which would improve the tactile perception of one or a plurality of areas by performing tactile stimulation on one or a plurality other areas.

### OUTLINE OF THE INVENTION

To this end, a system to generate tactile stimulations is provided according to the invention. The system is configured to generate tactile stimulations having generation times that follow a Poisson distribution with a lambda parameter comprised between 0.5 and 1.5.

The system improves the tactile perception of the area of a limb, e.g. an upper limb, and more particularly of the hand, by stimulating another part of the body, e.g. the face, optionally in addition to the classic local stimulation which consists in directly stimulating the injured area in the case of application to the medical field. As indicated hereinabove, the area the tactile perception which is to be improved could be an area inaccessible temporarily or in a more lasting way.

Indeed, it has been noticed that a sequence of tactile stimulations generated at times according to a Poisson distribution with a lambda parameter comprised between 0.5 and 1.5 and applied to an area of the body of a person makes it possible to improve the tactile perception of the area of application but also of another area of the body.

For example, such facial stimulation improves the tactile perception of the face but also of the upper limb.

The system can be used for the re-education of persons who have suffered a stroke. Indeed, the system stimulates an intact region (e.g. the face the tactile perception of which is generally preserved in people who have had a stroke) in order to improve tactile perception and hence the sensorimotor re-education of the affected region (e.g. the hand). The system has the advantage of allowing the affected region to benefit from the effects of tactile stimulations, without the improvement of tactile perception being affected by the damage related to the pathology, because tactile stimulations are performed on an intact region.

In addition, the part of the body that has been the subject of stimulation also shows an improvement in the tactile perception. Thereby, one and the same stimulation leads to the improvement of two areas, the stimulated area (e.g. the face) and another at a distance (e.g. the hand).

In one embodiment of the system, a duration separating two generation times of two successive tactile stimulations is comprised between 0.083 s and 3.013 s.

In one embodiment of the system, a duration of each tactile stimulation is comprised between 8 ms and 20 ms with a preferred value of 10 ms.

In one embodiment of the system, the system to generate tactile stimulations is configured to generate the tactile stimulations during an interval comprised between 20 minutes and 180 minutes, e.g. 20 minutes, 60 minutes, 120 minutes, or 180 minutes.

In one embodiment, the system to generate tactile stimulations comprises an actuator configured to generate the tactile stimulations and a controller coupled to the actuator and configured to control the actuator.

In one embodiment of the system, the actuator is configured to be applied against an area of a person's face, preferentially attached to the area.

The invention further relates to a method comprising at least one step of generating tactile stimulations by an actuator the generation times of which follow a Poisson distribution with a parameter lambda comprised between 0.5 and 1.5.

The method according to the present invention can be a therapeutic method, or a non-therapeutic method, for improving the tactile perception of a person.

In one embodiment of the method, a duration separating two generation times of two successive tactile stimulations is comprised between 0.083 s and 3.013 s.

In one embodiment of the method, a duration of each tactile stimulation is comprised between 8 ms and 20 ms with a preferential value of 10 ms.

In one embodiment of the method, the tactile stimulations are generated during an interval comprised between 20 minutes and 180 minutes, e.g. 20 minutes, 60 minutes, 120 minutes, or 180 minutes.

The invention further relates to a computer program product comprising program code instructions for executing the method described hereinabove, more particularly when said program is executed on a computer belonging to or connected to the system to generate tactile stimulations described hereinabove.

### BRIEF DESCRIPTION OF FIGURES

Other features, goals and advantages of the invention will be clear from the following description, which is purely illustrative and non-limited to, and is to be read with reference to the enclosed drawings wherein:

FIG. 1 shows the system of the invention.

FIG. 2 shows an example of use of the system of the invention.

FIG. 3 shows an example of the shape and duration of a tactile stimulation delivered by the system of the invention.

FIG. 4 shows an example of a set of tactile stimulations.

FIG. 5 shows an example of the distributions of a plurality of tactile stimulations, each having a different value of the lambda parameter.

### DETAILED DESCRIPTION OF THE INVENTION

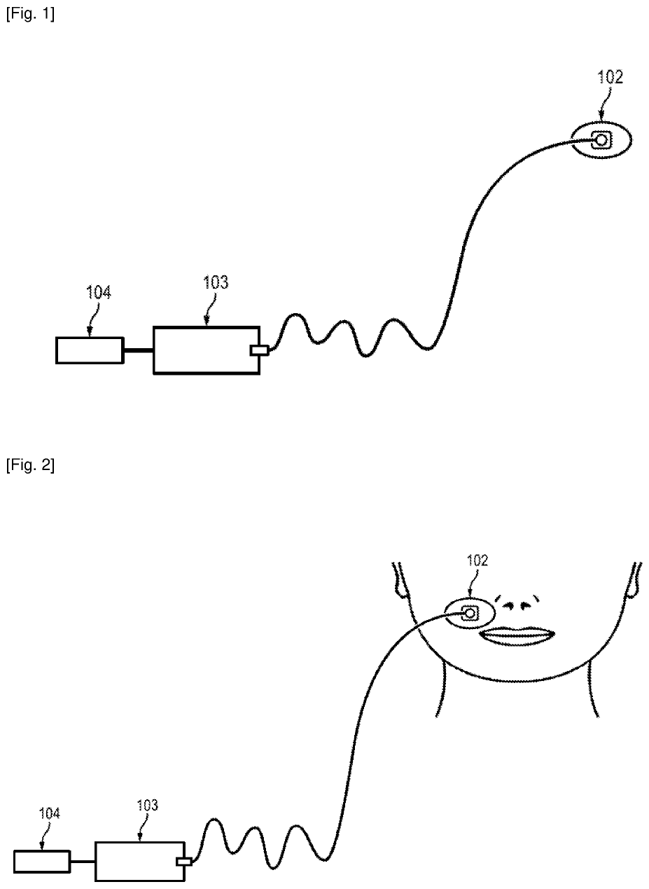

FIG. 1 shows a system 101 to generate tactile stimulations according to the invention. The stimulations are called passive, because same require no attention and no task from the person receiving the stimulations.

The system 101 comprises an actuator 102 which is a device to generate the tactile stimulations and a control unit 103 connected to the actuator 102 and configured to control the actuator 102 in order that the actuator generates the stimulations. The actuator 102 is e.g. a tactile actuator.

The control unit 103 is an electronic device, such as a computer, a pocket electronic device (such as a mobile phone, a smartphone), a portable digital player, or equivalent devices. The control unit 103 comprises a processing unit, a storage device and an electricity storage module 104. The control unit 103 can be connected to a computer (another computer, if the control unit 103 is already a computer) to configure the stimulation parameters. The control unit 103 has an ON/OFF activation system for starting/pausing/stopping the tactile stimulations delivered by the actuator 102 connected to the control unit 103, as well as an adjustment system for reducing/increasing the intensity of the tactile stimulations.

The processing unit can be a processor or a microcontroller for general or specific use, to control the tactile actuator 102, so that same generates the tactile stimulations.

For example, the processor can be an application-specific integrated circuit (ASIC) for managing and controlling the tactile stimulations generated by the actuator 102.

The control unit 103 is more particularly configured to control the duration, the shape, the frequency and the times of occurrence of the tactile stimulations generated by the actuator 102. The configuration of the different stimulation parameters is performed by connection to a computer. In another embodiment, the computer is integrated into the control unit 103.

The storage device can be fixed or removable and can include different storage units that can include a combination of units for volatile and non-volatile storage. The memory device is configured to store a software code which can be used by the processor to control the actuator 102. Same is further configured to store parameters representative of the tactile stimulations.

The electricity storage module 104 is e.g. a compartment for batteries (power bank) or cells. The module is used for supplying electricity to the control unit 103 and the actuator 102.

The control unit 103 and the actuator 102 are connected by connections, in order to exchange commands and/or signals representative of the tactile stimulations to be applied. Such connections can also be used for supplying electrical power to the actuator 102 by means of the control unit 103.

Thereby, the control unit 103 can carry out a method to control the actuator 102 so that the actuator generates tactile stimulations the generation times of which follow a Poisson distribution with a parameter lambda between 0.5 and 1.5 and advantageously between 1.15 and 1.2. The control unit 103 can comprise a computer program product comprising program code instructions for executing the method to control the actuator 102.

The actuator 102 can use a mechanism, electrical, vibratory or of any other kind, insofar as the mechanism can generate tactile stimulations. For example, the actuator 102 can generate a tactile stimulation by generating a flow of compressed air, an auditory signal or a magnetic wave. In one embodiment, the actuator 102 can use a vibratory system to provide stimulations to the skin when the vibratory system is placed in contact with the skin. The vibratory system can be e.g. a loudspeaker, which is a transducer intended to produce stimulations from an electrical signal.

In another embodiment, the actuator 102 receives pulses or commands to control the actuator 102 in order that the actuator generates stimulations on the skin, by the effect of an internal vibratory system, from an electrical signal. All pulses/commands cause and form the tactile stimulation. In one embodiment, the different elements of the control unit 103 and of the actuator 102 are positioned on the same support (e.g. on the same printed circuit).

In one embodiment, the controller 103 comprises a digital portable player or an equivalent device that generates a signal representative of the stimulation. The control unit 103 further comprises an amplifier, e.g. an audio amplifier, connected to the digital player in order to amplify the signal and transmit the signal to the actuator 102.

Tactile stimulations are usually applied to the face or other area of the skin using the actuator 102. In one embodiment, the actuator 102 comprises a non-adhesive support. In such case, the actuator 102 is pressed against the target area and the tactile stimulations are delivered, e.g. by contact between the actuator 102 and the target area. In such case, the actuator 102 is pressed against the target area of the face by means of a support suitable for the face. In one embodiment, the support is adhesive and/or bi-adhesive and the actuator 102 is attached to the target area of the face by means of the adhesive. The target area is e.g. the nose, the upper lip, the lower lip, the cheek, one of the ears or any other area or part of the body.

In one embodiment, the actuator 102 is not in contact with the area of the skin, e.g. a patch could be present between the area of the skin and the actuator 102.

The tactile stimulations make it possible to modify the perception of the stimulated region as well as of at least one other non-stimulated region.

The control unit 103 controls the actuator 102, so as to generate the tactile stimulations. The parameters of the tactile stimulations are determined by:
the distribution followed by the generation times of tactile stimulations, the distribution is a Poisson distribution with a lambda parameter comprised between 0.5 and 1.5. By moving away from said parameter range, the distribution of tactile stimulations no longer follows the desired distribution.
the maximum, minimum and average duration of the time interval separating two tactile stimulations (ISI or InterStimulus intervals), this maximum duration is 3.013 s, the minimum duration is 0.083 s and the average duration is 0.856 s. It is advantageous for the time intervals to satisfy the set durations in order to effectively trigger the expected effects. If the durations of the time intervals between two tactile stimulations become longer or shorter, also if the durations of the time intervals between two tactile stimulations are identical, other phenomena (e.g. habituation and/or depression) could prevent the induction of the expected effects.
the duration of the tactile stimulation sequence which is comprised e.g. between 20 minutes and 180 minutes, e.g. 20 minutes, 60 minutes, 120 minutes or 180 minutes
the duration of each tactile stimulation which is comprised e.g. between 8 and 20 ms.

Poisson's distribution is a discrete probability distribution that describes the occurrence of events occurring within a set time interval. More particularly, said probability distribution is used for determining the times at which the events occur, the average frequency between two events and the time elapsed between two events. The frequency and the elapsed time are parameterized by the parameter lambda (A).

FIG. 2 shows the system to generate tactile stimulations 101 according to a mode of use on the face. The actuator 102 is placed on a region of the face, allowing the tactile stimulations to stimulate the area of the skin in contact with the actuator 102.

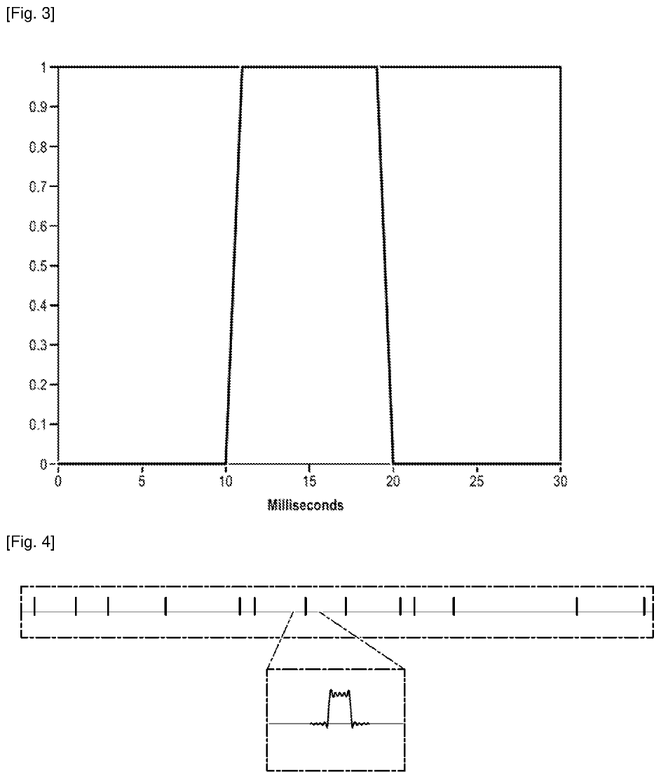

FIG. 3 shows an example of the shape and duration of a tactile stimulation delivered by the system of the invention.

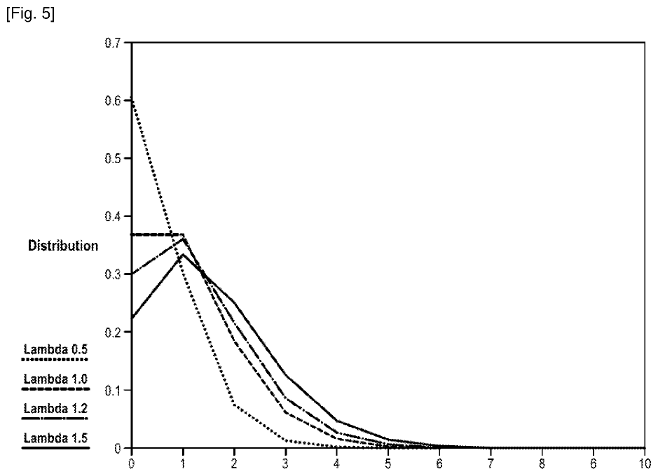

FIG. 4 shows an example of a set of tactile stimulations. Each vertical bar corresponds to tactile stimulation. The image of a single tactile stimulation is shown in the enlarged area at the bottom. The duration of the time interval between two tactile stimulations is not always the same. The duration has to satisfy defined parameters. The tactile stimulations are generated by the actuator 102 when the actuator receives pulses or commands from the control unit 103.

FIG. 5 shows an example of the distributions of a plurality of tactile stimulations, each having a different value of the lambda parameter. The tactile stimulations are generated by the actuator 102 when the actuator receives pulses or commands from the control unit 103.

1. A system of tactile stimulations configured to generate tactile stimulations having generation times that follow a Poisson's distribution with a lambda parameter comprised between 0.5 and 1.5.

2. The system of tactile stimulations according to claim 1, configured so that a duration of each tactile stimulation is comprised between 8 ms and 20 ms.

3. The system of tactile stimulations according to claim 1, configured to generate the tactile stimulations during an interval comprised between 20 minutes and 180 minutes.

4. The system of tactile stimulations according to claim 1, configured so that a duration separating two generation instants of two successive tactile stimulations is comprised between 0.083 s and 3.013 s.

5. The system of tactile stimulations according to claim 1, comprising:
an actuator configured to generate the tactile stimulations; and
a controller connected to the actuator and configured to control the actuator.

6. The system of tactile stimulations according to claim 5, wherein the actuator is configured to be applied against an area of a person's face.

7. A method comprising at least one step of generating tactile stimulations by an actuator, wherein generation times of the actuator follow a Poisson distribution with a lambda parameter comprised between 0.5 and 1.5.

8. The method according to claim 7, wherein a duration of each tactile stimulation is comprised between 8 ms and 20 ms.

9. The method according to claim 7, wherein the tactile stimulations are generated during an interval comprised between 20 minutes and 180 minutes.

10. The method according to claim 7, a duration separating two generation times of two successive tactile stimulations being comprised between 0.083 s and 3.013 s.

11. A computer program product comprising program code instructions encoded on a non-transient storage media, wherein the program code instructions are executable on a computer to perform the method according to claim 7.

12. The system of tactile stimulations according to claim 6, wherein the actuator is configured to be attached to the area.
